(19) United States
(12) Patent Application Publication
(10) Pub. No.: US 2007/0180152 A1
(43) Pub. Date: Aug. 2, 2007

(54) Method and apparatus to extend error-disable-and-ignore and port-bounce capability to a PC-facing port of an IP phone

(75) Inventor: Mark Montanez, Littleton, CO (US)

Correspondence Address: LAW OFFICE OF CHARLES E. KRUEGER, P.O. BOX 5607, WALNUT CREEK, CA, 94596-1607, US

(73) Assignee: Cisco Technology, Inc.

(21) Appl. No.: 11/342,201

(22) Filed: Jan. 27, 2006

(51) Int. Cl. G06F 15/16

(52) U.S. Cl. 709/250

(57) ABSTRACT

An IP phone is enabled to error-disable or bounce a port its on-board switch so that a connected device can be isolated if it transmits traffic violating a security policy without disconnecting the phone from the network.

### BACKGROUND OF THE INVENTION

Telephones using VoIP (Voice over Internet), commonly known as IP phones, provide exciting possibilities for integrating voice and data services to customers. IP phones are typically coupled to an Ethernet LAN and many models include an integrated Ethernet switch (the phone switch) that can be used to couple other devices to the Ethernet LAN.

In a typical configuration, the phone switch has one port coupled to the LAN, e.g., coupled to the port of a Layer 2 access switch, one port facing the phone circuitry, and one port facing an attached device. The phone switch allows infrastructure previously used only for data to be shared between voice and data.

Most network devices include security features that may be enabled by network administrators. One example of a set of security features is the Catalyst Integrated Security Feature Set (CISF) set distributed by the assignee of the present application. CISF provides features that prevent various types of attack on the network.

A typical response to a suspected attack is to disable the port connected to a device launching the attack. The response to a suspected attack coming from a PC coupled to the phone port of a switch in an IP phone will now be described.

FIG. 1 depicts the steps taken when an IP phone is attached to the LAN. The Layer 2 access switch detects the IP phone and applies power. In this example, the Layer 2 access switch utilizes Cisco Discovery Protocol CDP which is a data link protocol which gathers information about neighboring network devices.

The IP Phone is placed in the proper VLAN based on policies set up for the network, a DHCP request obtains an IP address, and the Layer 2 access switch configures the phone using call manager software.

FIG. 2 depicts an example of the network response if a PC attached to a port of the IP Phone transmits traffic in violation of the CISF Feature Set. The Layer 2 access switch detects the violation and error-disables the port of the Layer 2 access switch that detects the violating traffic. In this example, it is the port on the Layer 2 access switch that connects the phone switch to the LAN that is disabled. Accordingly, in this scenario the IP phone and the violating PC are disconnected from the network and taken out of service.

This is an example of network behavior that is unacceptable for telephone applications. By connecting a PC to the LAN through the phone switch the IP phone is subject to disconnection caused by the behavior of the PC. Users of PCs and network devices tolerate disconnections during use but users of telephones cannot tolerate disconnections and related service outages.

Another example of network behavior that it is unacceptable in telephony applications occurs when a VLAN change requires the PC attached to the phone switch port to change its IP address. Present behavior is to have the switch bounce, i.e., disable and enable the port in rapid succession, to cause the attached PC to issue a new DHCP request to renew its IP address. However, this bouncing of the switch port causes the phone to reset, which would cause a disconnection if the phone were being used.

The challenges in the field of voice and data integration continue to increase with demands for more and better techniques having greater flexibility and adaptability. Therefore, a need has arisen for a new system and method for applying security policies to integrated voice and data networks.

### BRIEF DESCRIPTION OF THE DRAWINGS

FIG. 1 is a flow chart depicting the steps taken when an IP phone is attached to a LAN;

FIG. 2 is a flow chart depicting the network response to a security violation;

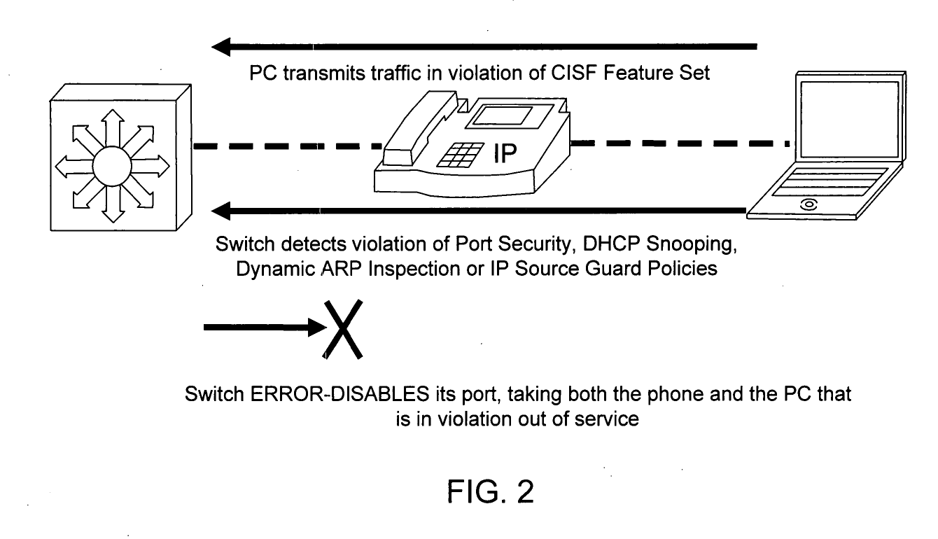

FIG. 3 is a block diagram of a system environment for implementing an embodiment of the invention;

FIG. 4 is a flow chart depicting the operation of an embodiment of the invention that disables the PC-facing port of the IP phone when the connected PC transmits in violation of a security policy; and

FIG. 5 is a flow chart depicting the operation of an embodiment of the invention that bounces the PC-facing port of the IP phone when the connected PC must change its IP address.

### DETAILED DESCRIPTION OF THE INVENTION

Reference will now be made in detail to various embodiments of the invention. Examples of these embodiments are illustrated in the accompanying drawings. While the invention will be described in conjunction with these embodiments, it will be understood that it is not intended to limit the invention to any embodiment. On the contrary, it is intended to cover alternatives, modifications, and equivalents as may be included within the spirit and scope of the invention as defined by the appended claims. In the following description, numerous specific details are set forth in order to provide a thorough understanding of the various embodiments. However, the present invention may be practiced without some or all of these specific details. In other instances, well known process operations have not been described in detail in order not to unnecessarily obscure the present invention.

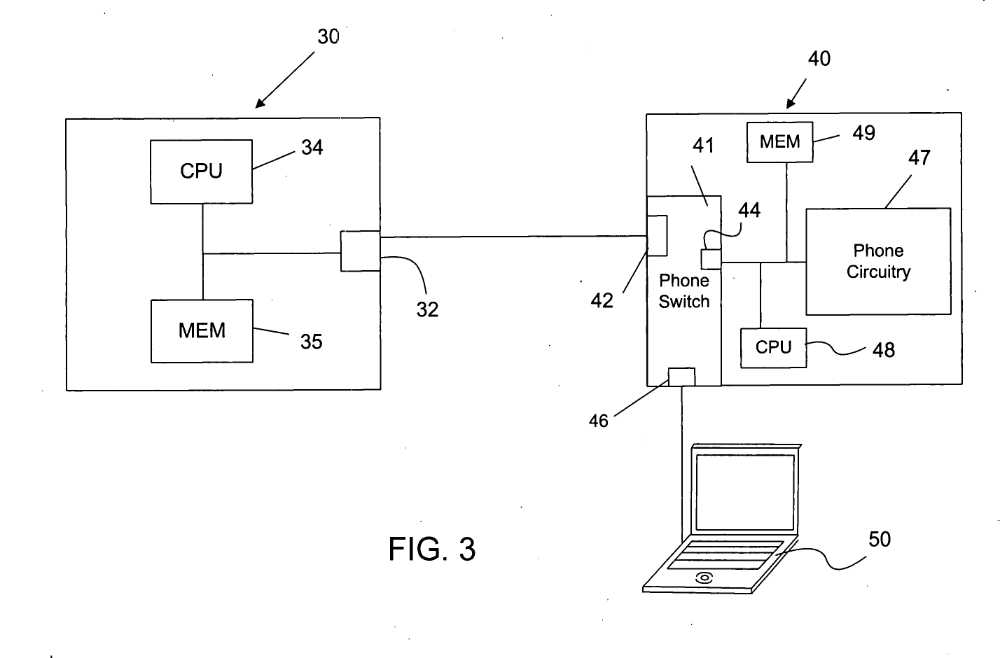

An embodiment of the invention will now be described that can be implemented in the standard system depicted FIG. 3. FIG. 3 is a high level block diagram of a Layer 2 access switch coupled to an IP phone. FIG. 3 schematically depicts only those components relevant to describing this embodiment.

FIG. 3 depicts a Layer 2 access switch 30 having a first port 32, switch CPU 34, and memory 35 storing program code, such as Internet Operating System (IOS)®, and data, such as configuration data. The IP phone 40 has a phone switch 41 including a network facing port 42, a phone circuitry port 44, and an auxiliary device port 46. The IP phone also includes phone circuitry 47 coupled to the phone circuitry port 44, a phone CPU 48, and memory 49, such as flash memory, for holding a lightweight version of IOS®.

A personal computer (PC) 50 is coupled to the auxiliary device port 46 and the network facing port 42 is coupled to the first port 32 of the Layer 2 access switch 30.

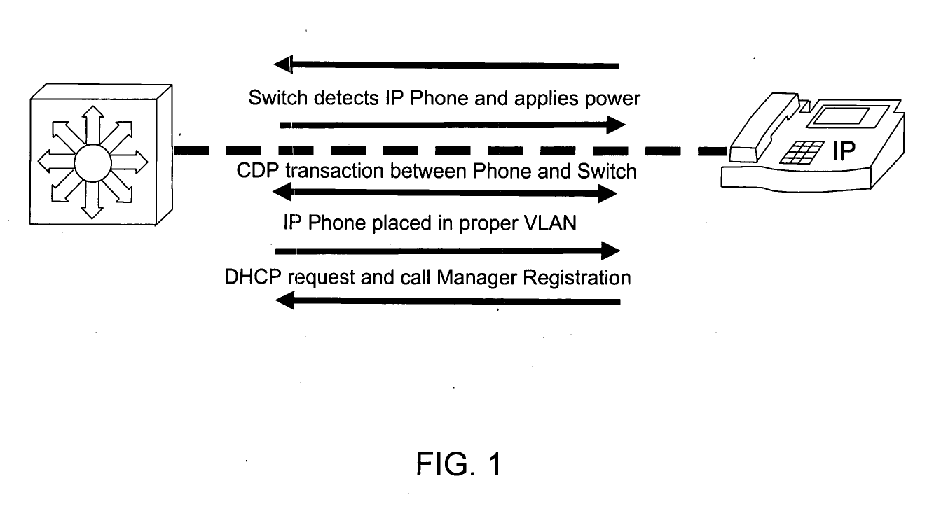

Referring again to FIG. 1, when the IP phone is connected to the Layer 2 access switch the switch CPU 34 executes program code to detect the IP phone, apply power, perform CDP transactions, and so. When the PC is connected to the LAN via the IP Phone the Layer 2 access switch responds to DHCP requests.

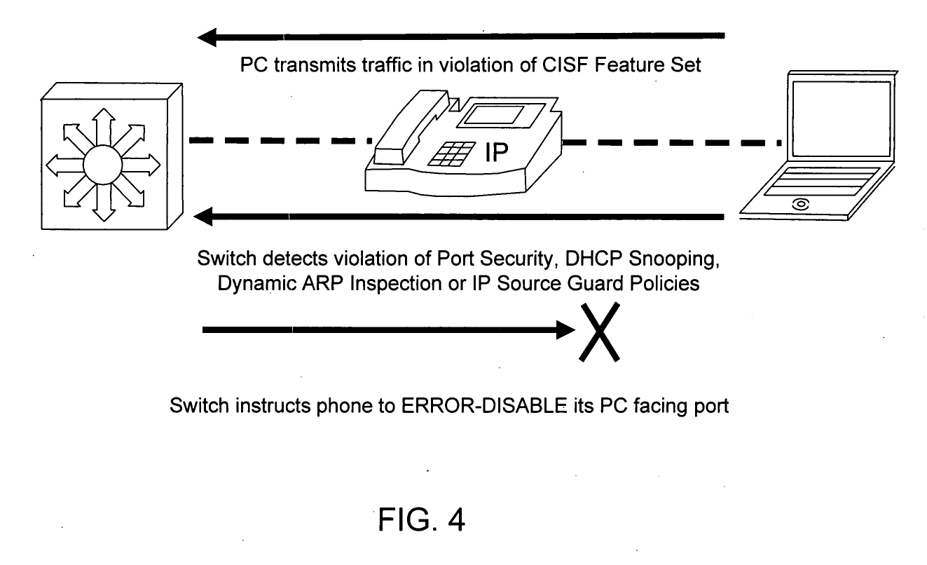

An overview of the operation of an embodiment of the invention will now be presented with reference to FIGS. 3 and 4. In FIG. 4, the PC transmits traffic in violation of a security requirement and the violation is detected by the switch. In this embodiment, instead of disabling the first port connecting the IP phone to the LAN, the switch instructs the IP phone to disable the auxiliary device port 46 on the phone switch 41. The other ports of the phone switch 41 are not disabled so that the phone circuitry 47 remains coupled to the LAN through the Layer 2 access switch. Thus, the user experiences no disruption of telephone service if the attached PC transmits traffic in violation of a security policy.

The operation of this embodiment will now be described in more detail. When the IP phone is connected and a PC is connected via the IP phone the Layer 2 access switch stores port data in memory indicating that the first port is connected to an IP phone and a connected PC. The Layer 2 access switch then configures its software so that special security modules in the switch IOS® will be run if a security violation is detected on the first port.

The types of security violations that can be detected include, but are not limited to, port security, BPDU guard, root guard, DHCP snooping, ARP inspection, and IP Source Guard Policies.

The IP phone also includes special modules in the phone IOS® image to disable the auxiliary device port if instructed to do so by the Layer 2 access switch.

This embodiment requires no upgrade of the hardware features of the Layer 2 access switch or IP phone and therefore does not increase the cost of those devices.

In operation, when the Layer 2 access switch detects a security violation at its first port it executes the special security module to utilize a layer 2 protocol, such as CDP, to instruct the IP phone to disable the auxiliary device port 46 on the phone switch. The IP phone detects the instruction and executes its special modules to disable the auxiliary device port 46.

Once the auxiliary device port 46 has been disabled, various procedures can be utilized to re-enable it. For example, the Layer 2 access switch can instruct the IP phone to re-enable the auxiliary device port periodically after a time-out period expires. Other techniques known in the art can be utilized.

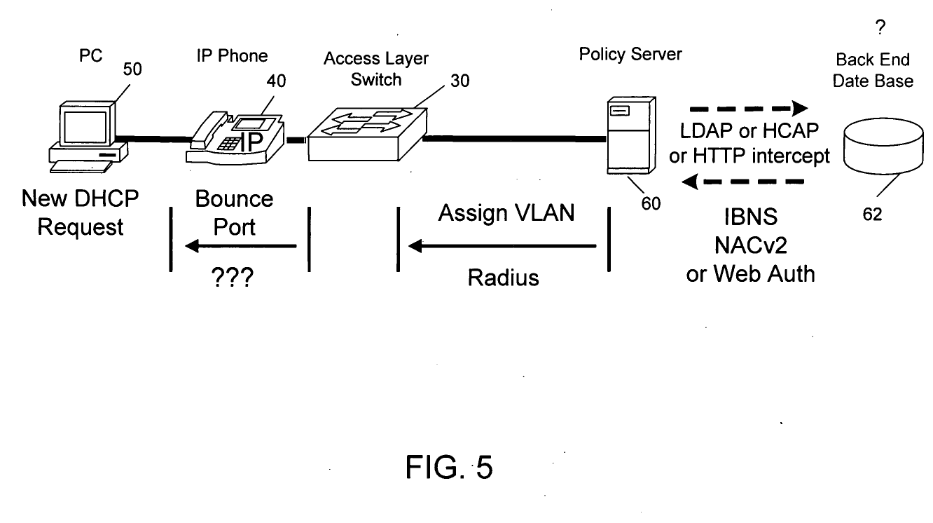

Additionally, the Layer 2 access switch can be enabled to instruct the IP phone to bounce the auxiliary device port if a VLAN change is made to the attached PC. This procedure will now be described in detail with reference to FIG. 5. FIG. 5 depicts the attached PC 50, IP phone 40, Layer 2 access switch 30, a policy server 60, and backend data base 62.

When a VLAN change is made the Layer 2 access switch executes program code to transmit a message, using, for example, CDP, to the IP phone instructing it to bounce the auxiliary port of the phone switch. The IP phone receives the signal and executes program code to cause the auxiliary device port to be disabled and then re-enabled in a short period of time. The attached PC issues a DHCP request and has its IP address changed to one that is valid in the subnet associated the VLAN to which the attached PC has been moved.

The IP phone is not reset when the auxiliary device port is bounced because the IP phone circuitry is not connected to the auxiliary device port. Thus, it is possible to move the attached PC to a new VLAN without resetting or rebooting the IP phone and possibly disconnecting a user.

In the above-described embodiment CDP has been described, by way of example, not limitation, as the layer 2 protocol utilized to communicate instructions to the IP phone. Other protocols, for example LLDP (Link Layer Discovery Protocol) and so on, can be utilized as is known in the art. Similarly, the IOS® operating system has been described by way of example, not limitation. Other switch operating systems can be modified as described above to implement embodiments of the invention.

The invention may be implemented as program code, stored on a computer readable medium, that is executed by a digital computer. The computer readable medium may include, among other things, magnetic media, optical media, electromagnetic fields encoding digital information, and so on.

The invention has now been described with reference to the preferred embodiments. Alternatives and substitutions will now be apparent to persons of skill in the art. In particular, the above-described embodiments have utilized a Layer 2 access switch. However, the invention can be implemented in networks utilizing routers, Layer 3 switches, etc. Accordingly, it is not intended to limit the invention except as provided by the appended claims.

What is claimed is:

1. A voice data network comprising:
an IP telephone including a phone switch, with the phone switch including a network facing port, a phone circuitry facing port, and an auxiliary device port, and with the IP telephone including a phone processor, and a phone memory holding phone program code, with the phone processor coupled to the phone memory and the phone switch, and with the phone processor configured to disable the auxiliary device port when disable instruct information is received at the network facing port; and
a network device having a first port coupled to the network facing port of the phone switch, with the network device including a device memory holding access device program code, and a device processor, with the device processor configured to monitor the first port for security violations and to transmit disable instruct information to the IP phone if a security violation is detected.

2. The voice data network of claim 1 wherein:
the phone processor is configured to bounce the auxiliary device port if port bounce device information is received at the network facing port; and
the device processor is configured to transmit bounce port information to the IP phone if an attached auxiliary device is to be assigned a new IP address.

3. A method for controlling an auxiliary port in an IP phone comprising:
providing an IP telephone with a phone switch, with the phone switch including a network facing port, phone circuit facing port, and an auxiliary device port;
receiving port-disable information at the network facing port of the phone switch;
error-disabling the auxiliary device port when said port-disable information is received;
providing a network device with a first port coupled to the network facing port of the phone switch;
monitoring the first port for security violations; and
transmitting port-disable information at the first port if a security violation is detected.

4. The method of claim 3 further comprising:
transmitting bounce-port information at the first port if a device attached to the auxiliary device port is to be assigned a new IP address;
receiving port-bounce information at the network facing port;
bouncing the auxiliary device port when port-bounce information is received.

5. The method of claim 1 further comprising the step of:
utilizing a layer 2 device recognition protocol for transmitting disable instruct information.

6. A voice data network including an IP phone and a network device, where the IP telephone includes a phone switch, with the phone switch having a network facing port, phone circuit facing port, and an auxiliary device port, and with the network device having a first port coupled to the network facing port of the phone switch, with said IP phone comprising;
means for receiving port-disable information at the network facing port of the phone switch;
means for error-disabling the auxiliary device port when said port-disable information is received;
with network device comprising:
means for monitoring the first port for security violations; and
means for transmitting port-disable information at the first port if a security violation is detected.

7. The system of claim 6 with the network device further comprising:
means for transmitting bounce-port information at the first port if a device attached to the auxiliary device port is to be assigned a new IP address;
and with the IP phone further comprising:
means for receiving port-bounce information at the network facing port;
means for bouncing the auxiliary device port when port-bounce information is received.

8. The system of claim 6 further with the network device further comprising:
means for utilizing a layer 2 device recognition protocol for transmitting disable instruct information.

9. A voice data network comprising:
an IP telephone including a phone switch, with the phone switch including a network facing port, a phone circuitry facing port, and an auxiliary device port, and with the IP telephone including a phone processor, and a phone memory holding phone program code, with the phone processor coupled to the phone memory and the phone switch, and with the phone processor configured to disable the auxiliary device port when disable instruct information is received at the network facing port.

10. The voice data network of claim 9 wherein:
the phone processor is configured to bounce the auxiliary device port if port bounce device information is received at the network facing port.

11. A voice data network comprising:
a network device having a first port coupled to a network facing port of a phone switch included in an IP phone, with the network device including a device memory holding access device program code, and a device processor, with the device processor configured to monitor the first port for security violations and to transmit disable instruct information to the IP phone if a security violation is detected.

12. The voice data network of claim 11 wherein:
the device processor is configured to transmit bounce port information to the IP phone if an attached auxiliary device is to be assigned a new IP address.

13. A method for controlling an auxiliary port in an IP phone comprising:
providing an IP telephone with a phone switch, with the phone switch including a network facing port, phone circuit facing port, and an auxiliary device port;
receiving port-disable information at the network facing port of the phone switch;
error-disabling the auxiliary device port when said port-disable information is received.

14. The method of claim 13 further comprising:
receiving port-bounce information at the network facing port;
bouncing the auxiliary device port when port-bounce information is received.

15. A method for controlling an auxiliary port in an IP phone, with the IP phone having a phone switch, with the phone switch including a network facing port, phone circuit facing port, and an auxiliary device port, said method comprising:
providing a network device with a first port coupled to the network facing port of the phone switch;
monitoring the first port for security violations; and
transmitting port-disable information at the first port if a security violation is detected.

16. The method of claim 15 further comprising:
transmitting bounce-port information at the first port if a device attached to the auxiliary device port is to be assigned a new IP address.

17. The method of claim 15 further comprising the step of:
utilizing a layer 2 device recognition protocol for transmitting disable instruct information.

18. An IP phone for use in a voice data network including an IP phone and a network device, where the IP telephone includes a phone switch, with the phone switch having a network facing port, phone circuit facing port, and an auxiliary device port, and with the network device having a first port coupled to the network facing port of the phone switch, with said IP phone comprising;
means for receiving port-disable information at the network facing port of the phone switch;
means for error-disabling the auxiliary device port when said port-disable information is received.

19. The IP phone of claim 18 with further comprising:
means for receiving port-bounce information at the network facing port;
means for bouncing the auxiliary device port when port-bounce information is received.

20. A network device for use in a voice data network including an IP phone and a network device, where the IP telephone includes a phone switch, with the phone switch having a network facing port, phone circuit facing port, and an auxiliary device port, and with the network device having a first port coupled to the network facing port of the phone switch, with said network device comprising;
means for monitoring the first port for security violations; and
means for transmitting port-disable information at the first port if a security violation is detected.

21. The system of claim 20 with the network device further comprising:
means for transmitting bounce-port information at the first port if a device attached to the auxiliary device port is to be assigned a new IP address.

22. The system of claim 20 further with the network device further comprising:
means for utilizing a layer 2 device recognition protocol for transmitting disable instruct information.
